(19) United States
(12) Patent Application Publication
(10) Pub. No.: US 2026/0097907 A1
(43) Pub. Date: Apr. 9, 2026

(54) Crossbelt Sorter

(71) Applicant: Interroll Holding AG, Sant' Antonino (CH)

(72) Inventors: Thomas Eisinger, Hückelhoven (DE); Florian Funk, Hückelhoven (DE)

(21) Appl. No.: 19/113,921

(22) PCT Filed: Sep. 25, 2023
(86) PCT No.: PCT/EP2023/076326

§ 371 Date: Mar. 21, 2025

(30) Foreign Application Priority Data
Sep. 28, 2022 (EP) 22198524.5

(51) Int. Cl. B65G 47/46; B65G 47/96

(52) U.S. Cl. CPC B65G 47/46; B65G 47/96

(57) ABSTRACT

Crossbelt sorter (1), adapted to sort an object (9) into one of a plurality of discharge stations (14); the crossbelt sorter (1) comprising a plurality of crossbelt carts (11); the crossbelt carts (11) are movable along a conveying direction (R) on a circumferentially closed conveying track (13); the crossbelt cart (11) comprising a crossbelt (12); wherein the crossbelt (12) provides a conveying surface for supporting an object (9) to be conveyed; the crossbelt (12) is moveable relative to the crossbelt cart (11) in a traverse direction (Q) traverse to the conveying direction (R); the crossbelt sorter (1) is adapted upon to transfer said object (9) from the conveying cart (11) selectively into one of the plurality of discharge stations (14) by selectively driving said crossbelt (12) in the traverse direction (Q) upon triggering; wherein for driving said crossbelt (12) of said crossbelt cart (11) has a drive wheel (42) which is adapted to engage with a friction bar (41); said friction bar (41) is stationary located along the track (13); characterized in that the crossbelt sorter (1) is adapted to vary a trigger position, where the transfer of said object (9) is triggered, within the range of a friction bar (41).

### CROSS REFERENCE TO RELATED APPLICATIONS

This application is the U.S. national stage of International Application No. PCT/EP2023/076326, filed on 2023-09-25. The international application claims the priority of EP 22198524.5 filed on 2022-09-28; all applications are incorporated by reference herein in their entirety.

### BACKGROUND

The invention refers to a crossbelt sorter.

A generic crossbelt sorter is shown in U.S. Pat. No. 6,273,268 B1 (references in this paragraph refer to this document). The crossbelt sorter comprises a plurality of crossbelt carts which are movable along a conveying direction on a circumferentially closed conveying track. A crossbelt on the crossbelt cart provides a conveying surface for supporting an object to be conveyed. The crossbelt is moveable relative to the crossbelt cart in a traverse direction traverse to the conveying direction. For driving said crossbelt the crossbelt cart has a drive wheel which is adapted to be selectively engaged by a friction bar. Here, the movement of the cross-belt is effected by means of friction bars installed in a fixed location on the travel path, which can be transferred between a driving position and a disengaged position. Resetting springs (FIG. 5, reference sign 40) act on the friction bars into their disengaged position (col. 3, I. 61-67; col. 6, I. 2-6; claim 9). In the driving position the friction bar gets in contact with a drive wheel on the crossbelt cart, resulting in a drive motion of the drive wheel. The drive wheel is connected with the crossbelt, leading to a drive operation of the crossbelt. The actuation of the friction bar into the driving position is performed by an electric or a pneumatic actuator, against the springs forces.

U.S. 2009/0057100 A1 discloses a cross belt sorter where the drive wheel is constantly in contact with a stationary friction bar. On the crossbelt cart a switchable clutch is provided. The clutch can selectively be switched between an open state and a state. In the closed state the clutch provides a drive connection between a drive wheel and the crossbelt, so that an object to be conveyed is sorted selectively into one of the discharge stations. In the open state the drive connection is interrupted so that an object remains on the cart.

In the sorter according to U.S. 2009/0057100 A1 the clutch is designed as a magnetic clutch and stationary electromagnets provided along the track to activate the clutch. The energy for operating the clutch is transferred magnetically between the stationary electromagnet and the magnetic clutch over a certain distance, requiring large magnetic devices. The position of the stationary electromagnet is not changed during the normal operation of the sorter.

JP H06-191635 A discloses a crossbelt sorter having an slightly different activation mechanism. Here a clutch is provided on the crossbelt car, which selectively provides a drive connection between a drive wheel and the crossbelt. A plurality of electromagnets are provided along the track, which provides the power to switch the clutch from the open state into the closed state.

U.S. Pat. No. 10,377,576 B2 discloses a facility for sorting items by ejecting the items into a receiving device. During ejecting the items describe true paths, which being liable to belong to a predefined set of potential paths considered as being incorrect. To eject the items on a correct path, operating parameters can be modified. The operating parameters to be modified are: an ejection speed of at least one of the items with respect to the receiving device; a time for triggering the ejection of at least one of the items, a time lapse between said triggering time and a time reference, or a speed of movement of at least one of the supports with respect to the receiving device.

U.S. Pat. No. 6,820,561 B2 discloses a cross-belt sorter, having an electric motor for activating the cross-belt.

Generally, crossbelt sorters use a frictional contact between the crossbelt and the object to accelerate the object in the traverse direction. Delaying effects are to be considered. Those delaying effects depend on the size, the weight and the surface of the conveyed object. In contrast to the crossbelt sorters, there are sorters which uses pusher shoes, which positively pushes the objects in the traverse direction, see e.g. pushing shoes 16 in FIG. 1 of U.S. Pat. No. 10,640,302 B2. Due to the positive pushing contact, the delaying effects are not given in such shoe sorters.

All of the above crossbelt sorters require discrete equipment for activating the movement of the crossbelt, which is located stationary along the conveying track. The stationary equipment constitutes something like a hard programming of the conveying functionality, preventing any dynamic and/or fine adjustments of the sorter behavior.

### SUMMARY

Crossbelt sorter (1), adapted to sort an object (9) into one of a plurality of discharge stations (14);
the crossbelt sorter (1) comprising a plurality of crossbelt carts (11);
the crossbelt carts (11) are movable along a conveying direction (R) on a circumferentially closed conveying track (13);
the crossbelt cart (11) comprising a crossbelt (12);
wherein the crossbelt (12) provides a conveying surface for supporting an object (9) to be conveyed;
the crossbelt (12) is moveable relative to the crossbelt cart (11) in a traverse direction (Q) traverse to the conveying direction (R);
the crossbelt sorter (1) is adapted upon to transfer said object (9) from the conveying cart (11) selectively into one of the plurality of discharge stations (14) by selectively driving said crossbelt (12) in the traverse direction (Q) upon triggering;
wherein for driving said crossbelt (12) of said crossbelt cart (11) has a drive wheel (42) which is adapted to engage with a friction bar (41);
said friction bar (41) is stationary located along the track (13); characterized in
that the crossbelt sorter (1) is adapted to vary a trigger position, where the transfer of said object (9) is triggered, within the range of a friction bar (41).

### DETAILED DESCRIPTION

It is an object of the present invention to provide an improved sorter in particular with respect of adjustability.

The invention comprises a crossbelt sorter and a method according to the main claim; embodiments are subject of the subclaims and the description.

In an inventive crossbelt sorter the object to be conveyed is accelerated in the traverse direction in particular merely by a frictional contact between the crossbelt and the object. Consequently no shoe is provided for which positively pushes the object in the traverse direction.

In particular a rearward is a position along the track is apposition which is passed by the cart at an earlier point in time than a forward position; in other words: the forward position is located downstream of a rearward position.

In particular the position of stationary components are not changed during the normal operation; during installation and maintenance the position may be adapted.

In the inventive crossbelt sorter the drive wheel is in contact the friction pad in dependent whether the crossbelt is to be driven or not. The clutch selectively connects the drive wheel with the crossbelt so as to start driving the crossbelt.

In particular in the object is selectively accelerated in the traverse direction by frictional engagement between the crossbelt and the object.

The inventive crossbelt sorter has the advantage that during operation the operation characteristics can be optimized. In contrast to the prior art the activation position can be amended to adapt the cross belt sorter to various framework or changing requirements without the need to reposition the overall position of the friction bar at all.

In particular also the power to close the clutch is also provided by a drive wheel, contacting the friction bar. Consequently no other device for transferring a large amount of energy is required. For activation of the clutch merely a small amount of information energy needs to be transferred to the cart.

### BRIEF DESCRIPTION OF THE DRAWINGS

The invention is explained in more detail below with reference to the figures; herein show:

FIG. 1 a crossbelt sorter in top view;

FIG. 2 a sectional view of the cross belt cart of the crossbelt sorter of FIG. 1 according to the line II-II in FIG. 1.

FIG. 3 schematically the components of an inventive cross belt sorter in a first embodiment;

FIG. 4 schematically the components of an inventive cross belt sorter in a second embodiment;

FIG. 5 schematically the components of an inventive cross belt sorter in a third embodiment;

FIG. 6 a diagram showing the relation between the cart speed and the triggering position in the inventive crossbelt sorter.

### DETAILED DESCRIPTION OF THE PREFERRED EMBODIMENTS

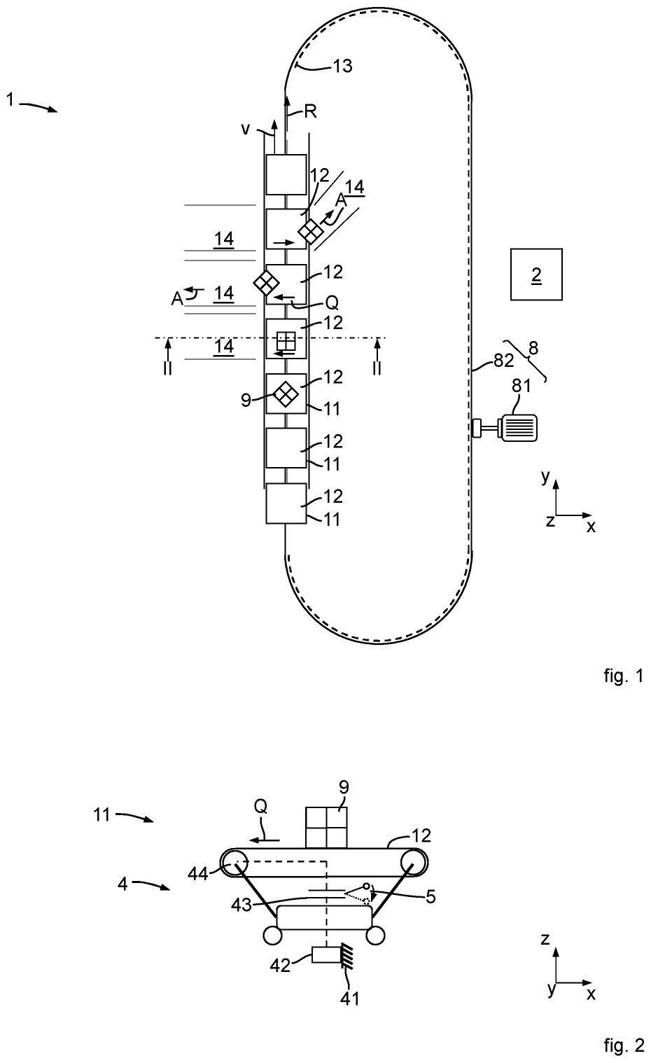

FIG. 1 shows a crossbelt sorter 1. The crossbelt sorter 1 comprises a plurality of crossbelt carts 11, which travel circumferentially in conveying direction R along a closed track 13. On top of each of the carts 11 a crossbelt 12 is provided. A top surface of the crossbelt 12 provides the conveying surface for supporting an object 9 to be conveyed.

A plurality of discharge stations 14 is provided, at which the object 9 can be selectively removed from the crossbelt cart 11 and conveyed to a discharge station 14 provided laterally of the crossbelt cart 11. For this purpose, the crossbelt 12 is set in motion on the crossbelt cart 11 in a direction Q transverse to the conveying direction R. A central controller 2 is controlling the operation of the different actuators within the crossbelt sorter 1.

FIG. 2 shows the mechanism for driving the crossbelt 12. A crossbelt drive 4 is provided to provide a drive force to the crossbelt 12. Along the track 13 a fixed friction bar 41 is provided which is at least during regular operation continuously in a driving position. In particular the friction bar 41 is fixed and cannot be transferred in a disengaged position.

The drive connection 4 has a drive wheel 42 positioned on the crossbelt cart 11. The friction bar 41 gets in frictional contact with said drive wheel 42, when the drive wheel 42 is passing the friction bar 41. Due to the relative movement of the drive wheel 42 along the conveying direction R, the friction bar 41 sets the drive wheel 42 into rotation.

In the drive connection 4 between the drive wheel 42 and the crossbelt 12 a switchable clutch 43 is provided. The clutch 43 is adapted to selectively enable and prevent the transmission of drive power from the drive wheel 42 to the crossbelt 12.

Finally the crossbelt 12 is driven by a driven roller 44, which is attached to the clutch 43. In the closed state of the clutch 43 drive power can be transferred between the friction bar 41 and the driven roller 44 to drive the crossbelt 12. In the open state of the clutch 43 no drive power can be transferred between the friction bar 41 and the driven roller 44 so the crossbelt 12 is not driven.

The clutch 43 is actuated by a clutch actuator 5.

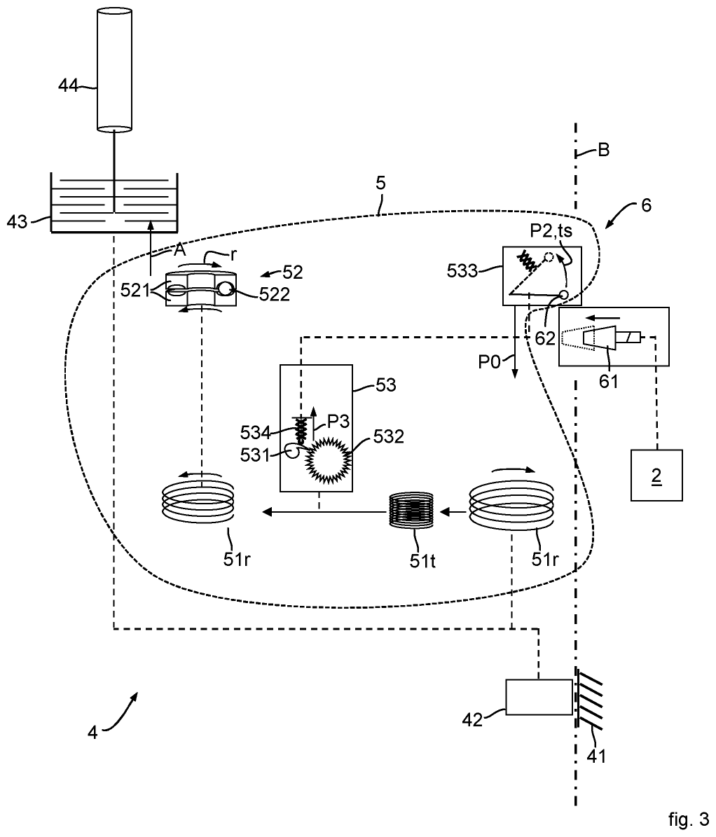

FIG. 3 shows schematically the mechanism in an inventive crossbelt sorter to activate the crossbelt, wherein the components of the crossbelt drive 4 correspond in main to the components shown in FIG. 2.

Reference number B shows here the system border between the shown components located on the crossbelt cart 11 and the components located stationary along the track 13.

Also in the embodiment of FIG. 3 a clutch 43 is provided between a driven roller 44 driving the crossbelt 12 and a drive wheel 42, interacting with a friction bar 41. A clutch actuator 5 comprises an actuating member 52. The actuating member 52 can selectively provide an actuating force A to the clutch 43, which transfers the clutch 43 from an open state into a closed state.

As an example the actuating member 52 is a ball ramp actuator 52, having two ramps 521 and at least a ball 522 located between the ramps 521. The ramps 521 having an increasing inclination in circumferential direction. Here a relative rotary movement r between the ramps 521 leads to a generation of an axial actuating force A. In principle the clutch 43 and the actuating member 52 can be a combined ball ramp loaded friction plate combination as shown e.g. in EP 0 793 033 B1.

The actuating member 52 is driven by a force storage 51. Here the force storage 51 may comprise a torsion spring. On an input side the force storage 51 is connected to a drive wheel 42. Rotation of the drive wheel 42 leads to a tensioning of the force storage 51. Reference number 51r depicts the force storage 51 in the released state; reference number 51t depicts the force storage 51 in the tensioned state. The drive wheel 42 may be identical to the drive wheel 42 described above, or may be a separate drive wheel 42, also cooperating with the friction bar 41.

Means for wind-up a tensioning spring are well known in the art and are e.g. widely used in the field of toys, e.g. as described in U.S. Pat. No. 3,981,098 A. Such a wind-up mechanism also comprise safety means preventing a over-tensioning of the spring.

The force storage 51 is held in the tensioned state and can selectively be released by means of a releasing device 53. In an exemplary embodiment the releasing device 53 has a ratchet pawl 531 engaging a ratchet gear 532. The ratchet gear 532 may be rotationally fixed with the torsion spring 51. In an engaging position said ratchet pawl 531 engaging the ratchet gear 532 preventing the torsion spring 51 from transferring into the released state from the tensioned state. There are plenty of other mechanisms possible. A resetting spring 534 is urging the ratchet pawl 531 in the engaging position.

The releasing device 53 adapted to displace the ratchet pawl 531 from the engaging position into a releasing position. In the releasing position the ratchet pawl 531 does not hold the force storage 51 is in the tensioned state. For displacing the ratchet pawl 531 into the releasing state the releasing device 53 comprises a releasing actuator 533 (as shown in FIG. 3, the actuator may be provided distant to the other components of the releasing device 53).

The releasing actuator 533 is in the example a mechanical actuator. As an further example, a displacement of a lever arm (arrow P2 in FIG. 3) may lead to the transfer of the ratchet pawl 531 in the disengaged position (arrow P3 in FIG. 3).

The releasing actuator 533 is triggered by a trigger 6. The trigger 6 has a first trigger part 61, which is stationary located along the track (in FIG. 3 on the right side of the system border B). The first trigger part 61 can be transferred between a non-triggered state (solid lines in FIG. 3) and a triggering state (dotted lines in FIG. 3). The trigger 6 has a second trigger part 62. The second trigger part 62 is located on the crossbelt cart 11 (in FIG. 3 on the left side of the system border B) and moves relative to the first trigger part 61 (see arrow P0).

When the second trigger part 62 passes the first trigger part 61 and if the first trigger part 61 is in the triggering state, the trigger 6 will trigger the releasing actuator 533 to transfer the ratchet pawl 531 into the releasing position. This causes releasing of the force storage 51 from the tensioned state in to the released state. Now the force storage 51 provides energy for the actuating member 52 to close the clutch 43. As soon as the clutch 43 is closed, the driven roller 44 drives the crossbelt 12 and the object 9 will be sorted out.

To support triggering the sorting operation for a plurality of discharge stations, the trigger 6 comprises several first trigger parts 61, which are located along the track 13 in spatial relation to the discharge stations, only one of which is shown in FIG. 3. At the same time, each of the carts 11 has its own second trigger part 62.

The first trigger part 61 can merely adopt one of two states, i.e. the triggering state and the non-triggering state.

It is obvious from the figure, that the power required for operating the releasing device 53 is much smaller than the power for operating the actuating member (here provided by the tensioned force storage 51). So the energy which needs to be transferred by the trigger device to the crossbelt cart 12 is quite low and can be transferred by the trigger 6 mechanically.

In addition to the first trigger part 61 shown in FIG. 3 a plurality of further first trigger parts 61 are provided along the track 13 to enable trigger of the clutch actuator at different position. In particular a separate first trigger part 61 needs to be provided at the track 13 in front of each discharge stations 14.

The mechanical trigger solution of FIG. 3 and fig. can transmit the trigger energy and the trigger information at discrete positions. Consequently the position of the cart, where the clutch actuator 52 is actuating clutch and consequently the sort out process is started, is hard coded by the position of the stationary trigger.

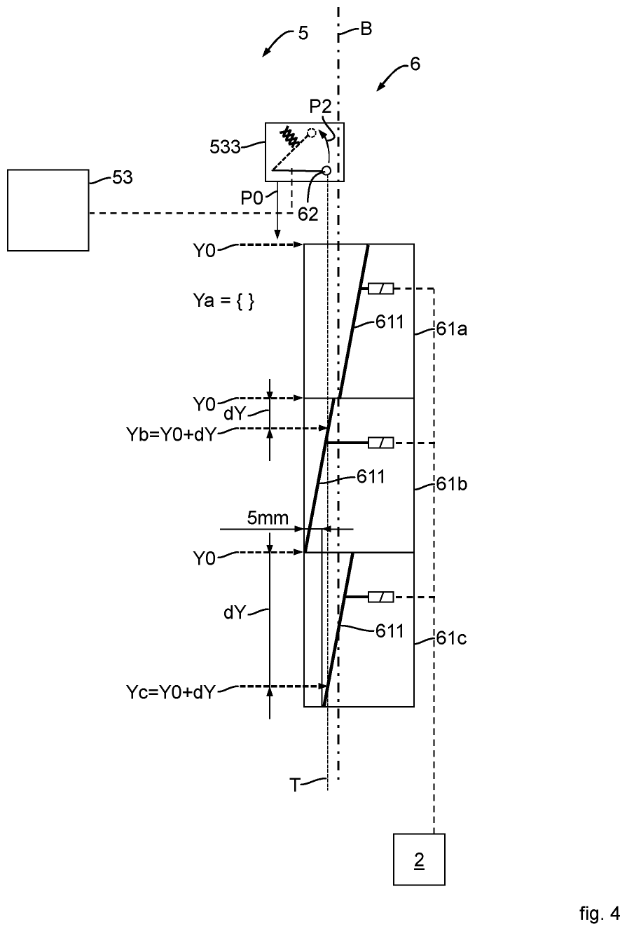

FIG. 4 shows an improved embodiment of the trigger 6 based on the FIG. 3, which can be applied in the arrangement shown in FIG. 3. In addition to the FIG. 3 a plurality of first stationary trigger parts 61a-c are shown.

Each trigger part 61 has a first trigger ramp 611 which can selectively protrude into the path of travel T of the second trigger part 62. The first trigger part 61a is in the non-triggering state, so the respective first trigger ramp 611 does not protrude into the path T.

The other first trigger part 61b, c are in the triggering state, so the respective first trigger ramps 611 protrude into the path T.

In contrast to the embodiment of FIG. 3 the triggering state of the first trigger parts 61a-c can have different quantitative forms. In the present exemplary situation a first trigger part 61b is moved out further than the other first trigger part 61c, e.g. about 5 mm.

This leads to a modification in the position along the track 13, where triggering is actually performed. Y0 defines herby the first possible triggering position for each first trigger part 61a-c. In case the ramp is fully extended, the second trigger part 62 will interact with the first trigger part 61 at foremost position Y0, so that the sort out operation will start at earliest possibility with respect to the individual first trigger part 61.

For the other first trigger part 61b triggering will happen at position Yb (where the first trigger ramp 611 meets the path T), which is located at a distance of dY after the foremost trigger position Y0. Distance dY constitutes a variable trigger shift, which can be selectively modified.

For the other first second trigger part 61c triggering will happen at position Yc, which is located at a trigger shift of dY.

As can be seen by comparing the first triggers 61c and 61b, the trigger shift dY can be modified selectively by amending the “move-out”-scope of the first trigger ramp 611, which is performed by an first trigger part actuator 612 of the first trigger part 61, controlled by any controller e.g. the central controller 2.

Consequently even if the trigger 6 has first trigger parts 61 which are located at discrete locations, the trigger positions relation to each first trigger part 61 can be adjusted flexibly and stepless.

Various actuators can be used instead of the actuator shown in FIG. 4. For example, the electromagnetic subactuators can be replaced by pneumatic subactuators.

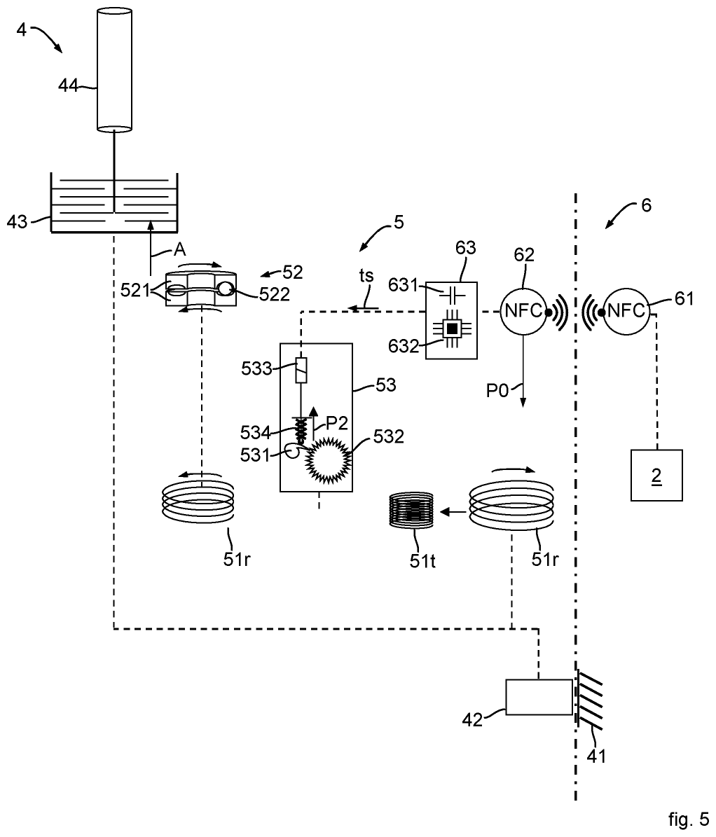

FIG. 5 shows an alternative mechanism to the mechanism shown in FIGS. 3 and 4. The above description is valid also for this embodiment, with the exception of the following deviating description.

Instead of the (mechanical) trigger 6 of FIG. 3 the first/stationary trigger part 61 and the second/mobile trigger part 62 interact contactless with each other. Each of the trigger parts 61, 62 is, as an example, designed as a NFC (near filed communication) device. When second trigger part 62 is passing the first trigger part 61, a trigger signal is provided via NFC to the releasing device 53, in particular to the releasing actuator 533 of the releasing device 53, triggering the releasing device 53 to enable releasing of the force storage 51 from the tensioned state in to the released state as described above.

The NFC technology is just a suitable example for the present invention, which is able to transfer in contactless manner,
a) the information required for triggering the releasing device 53;
b) the energy (power transfer) required by the releasing device 53 for actuating the releasing action.

A required power transfer may be about 10W, which can be transferred via NFC or similar near filed communication technologies. Alternatively to NFC the contactless trigger parts can interact with each other according to the Qi standard, which also allows a transfer of sufficient energy and information for actuating the release device. Also the trigger device may use separate technologies for transferring information and energy, e.g. an inductive technology for energy and an optical data transfer for information transfer.

Analog to FIG. 4, a plurality of first trigger parts 61 are located at discrete positions along the track 13 (only one of which is shown in FIG. 5).

As soon as the second trigger part 62 passes the first trigger part 61, the trigger may issue a trigger signal ts for the clutch actuator 5, trigger occurs at the foremost trigger position Y0, analog to FIG. 4.

To enable a trigger shift dY analog to FIG. 4 the trigger 6 comprises a trigger timer 63. In particular the trigger timer 63 delays the trigger signal ts so that the trigger signal ts will arrive at the clutch actuator 5 at a certain delay, so that the crossbelt cart 11 has already traveled the trigger shift dY. The amount of said delay can be part of an information content provided by the control unit and transferred wirelessly between the first and the second trigger part 61, 62.

In an example the trigger timer 63 has a time controller 632 which calculates the time delay and which provides the trigger signal ts at the certain time delay. An energy storage 631 may be provided which in particular provides electrical energy for the trigger timer 63 when the second trigger part 62 cannot provide energy anymore (this may happen when the second trigger part 62 is not in contact anymore with the first trigger part 61). The energy storage 631 may be a small electrochemical accumulator or a capacity. The energy storage 631 may be part of the timer 63.

The components in the embodiment shown in FIG. 3ff are merely exemplary. So any other force storage may be used, in particular an air spring, a linear spring, or any other kind of force storage.

In any case it is advantageous if the force for loading the force storage 51 results mechanically from the relative movement between the crossbelt cart 11 and the stationary friction bar 41 instead of being provided electrically via electrical sliding contacts.

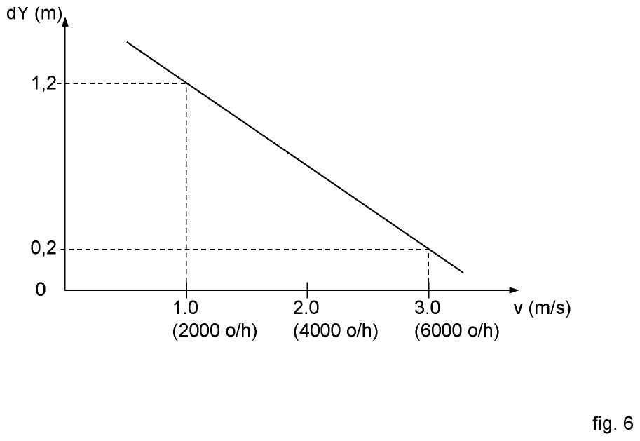

FIG. 6 shows a diagram. Here “v” defines a travel speed, at which the crossbelt carts 11 travel along the track 13 (see FIG. 1).

In an inventive usage of the sorter a travel speed v of the sorter carts can be adapted. The travel speed v correlates linearly with the maximum number of objects 9, which can be sorted per hour. As an example, at a travel speed of 2.0 m/s a maximum of 4000 objects 9 per hour (“o/h”) can be sorted; consequently at a travel speed v of 1.0 m/s a maximum of 2000 o/h can be sorted.

The crossbelt sorter 1 is adapted to be driven at different capacity conditions. During e.g. Christmas trade the utilization of the sorter requires 6000 objects to be sorted per hour, so the crossbelt carts 11 needs to be operated at a travel speed v of 3 m/s. In the summer slump the utilization requires merely 2000 objects to be sorted per hour, so the crossbelt carts 11 needs to be operated at a travel speed v of 1 m/s.

So prior to amending the travel speed v, in a determination step, a quantity of objects to be handled by the sorter may be determined. Said determination can be done by obtaining a respective input value received from a supervising control device. In an alternative way the determination can be done automatically by a sorter control itself. Thereby the sorter may observe the occupancy status of the sorter carts. In case that merely 60% of the sorter carts are occupied, it is detected, that the quantity of objects is merely 60% of the full handling capacity at the current speed. Accordingly a reduced speed can be determined, which still ensures sufficient handling of all objects to be handled, thereby saving energy costs and preserve wear parts.

For proper sorting of objects 9 into the discharge stations 14, the start point for accelerating the objects is depending on the travel speed of the crossbelt carts 11. To meet the correct discharge station 14 an object 9 needs to be accelerated earlier in case of a high cart travel speed, than in case of low cart travel speed.

So for proper sorting of the objects 9 at a travel speed v of 1.0 m/s, an exemplary trigger shift dY is to be set to 1.2 m, whereas at a travel speed v of 3.0 m/s, an exemplary trigger shift dY is to be set to 0.2 m. In other words: at a travel speed v of 3.0 m/s, the clutch 43 is to be closed at a position 1.0 m ahead compared to a position where the clutch 43 is to be closed at a travel speed v of 1.0 m/s.

### LIST OF REFERENCE NUMERALS

1 crossbelt sorter
2 central controller
4 crossbelt drive/drive connection
5 clutch actuator
6 trigger
8 stationary cart drive
81 stationary drive motor
82 traction means/traction belt
9 object to be conveyed
11 crossbelt cart
12 crossbelt
13 track
14 discharge station
41 friction bar
42 drive wheel
43 clutch (open state/closed state)
44 driven roller
51 force storage/torsion spring (released state/tensioned state)
51r force storage in released state/released spring
51t force storage in tensioned state/tensioned spring
52 actuating member/ball ramp actuator
521 ramp
522 ball
53 releasing device
531 ratchet pawl (engaging position/releasing position)
532 ratchet gear
533 releasing actuator
534 resetting spring
61a,b,c first/stationary trigger part
611 first trigger ramp
612 first trigger part actuator
62 second/mobile trigger part
63 timer
631 energy storage
632 time controller
R conveying direction
Q traverse direction
A actuating force
r rotary movement
B system border
T path of travel of first trigger part
Ya, Yb, Yc trigger position
Y0 foremost trigger position
dY trigger shift
v travel speed of crossbelt cart
ts trigger signal

1. Crossbelt sorter (1), adapted to sort an object (9) into one of a plurality of discharge stations (14);
the crossbelt sorter (1) comprising a plurality of crossbelt carts (11);
the crossbelt carts (11) are movable along a conveying direction (R) on a circumferentially closed conveying track (13);
in particular the crossbelt carts are driven by means of a stationary cart drive (8), the stationary cart (8) drive in particular comprising a stationary drive motor and a traction (82),
each of the crossbelt carts (11) comprising a crossbelt (12);
wherein the crossbelt (12) provides a conveying surface for supporting an object (9) to be conveyed;
the crossbelt (12) is moveable relative to the crossbelt cart (11) in a traverse direction (Q) traverse to the conveying direction (R);
the crossbelt sorter (1) is adapted upon to transfer said object (9) from the conveying cart (11) selectively into one of the plurality of discharge stations (14) by selectively driving said crossbelt (12) in the traverse direction (Q) upon triggering;
wherein for driving said crossbelt (12) of said crossbelt cart (11) has a drive wheel (42) which is adapted to engage with a friction bar (41);
said friction bar (41) is stationary located along the track (13);
characterized in
that the crossbelt sorter (1) is adapted to vary a trigger position, where the transfer of said object (9) is triggered, within the range of a friction bar (41),

2. Crossbelt sorter (1) according to claim 1,
characterized in
that within the range of said friction bar (41) said trigger position (Y0, Ya, Yb, Yc) can be shifted in direction along the track (13).

3. Crossbelt sorter (1) according to claim 1,
characterized by
a clutch (43) transferable between an open state and a closed state;
the clutch (43) is located on the crossbelt cart (11),
the clutch (43) is adapted to selectively close, and in particular to open, a drive connection (4), wherein the drive connection (4) transmits drive power to the crossbelt (12) for driving the crossbelt (12) in the traverse direction (Q).

4. Crossbelt sorter (1) according to the preceding claim 3,
characterized in
that on the crossbelt cart (11) a clutch actuator (5) is provided;
the cutch actuator (5) is adapted to selectively transfer the clutch (43) into the closed state.

5. Crossbelt sorter (1) according to claim 4,
characterized in
the clutch actuator (5) comprising a mechanical force storage (51) located on the crossbelt cart (11),
the mechanical force storage (51) is adapted to store mechanical power on the crossbelt cart (11),
the clutch actuator (5) is adapted to use the mechanical power stored in the force storage (51) to transfer the clutch (43) into the closed state.

6. Crossbelt sorter (1) according to claim 4,
characterized in
that the power for operating the clutch actuator (5), in particular the power to transfer the clutch (43) into the closed state, is provided mechanically to the crossbelt cart (11).

7. Crossbelt sorter (1) according to claim 4,
characterized in
that the power for operating the clutch actuator (5), in particular the power to transfer the clutch into the closed state, is provided by a drive wheel (42) engaging with a stationary friction bar (41).

8. Crossbelt sorter (1) according to claim 4,
characterized in,
that the clutch actuator (5) comprises a releasing device (53), the releasing device (53) is adapted to initiate the transfer of the clutch (43) into the closed state.

9. Crossbelt sorter (1) according to claim 8,
characterized in
that the releasing device (53) is adapted to release power stored in the force storage (51) located on the crossbelt cart (11),
the power used by the clutch actuator (5) for transferring the clutch (43) into the closed state.

10. Crossbelt sorter (1) according to claim 4,
characterized by
a trigger (6),
the trigger (6) has a first trigger part (61) located stationary along the track (13);
the trigger (6) has a second trigger part (62) located on the crossbelt cart (11),
the first trigger part (61) and the second trigger part (62) are adapted to interact with each other,
wherein based on the interaction between the first and second trigger parts (61, 62) the clutch actuator (5) is triggered to transfer the clutch (43) into the closed state
in particular the trigger (6) is adapted to provide a trigger signal (ts) to the clutch actuator (5),
in particular wherein upon receipt of the trigger signal (ts) the clutch actuator (5) transfers the clutch (43) into the closed state.

11. Crossbelt sorter (1) according to claim 10,
characterized by
a timer (63),
the timer (63) is adapted to selectively control the timing of a trigger signal (ts), so that starting from a foremost trigger position the triggering of the clutch actuator (5) can be performed selectively by a trigger position Ya, Yb, Yc, that is located further backwards along the track (13).

12. Method of operating a crossbelt sorter (1),
the crossbelt sorter (1) comprising a plurality of crossbelt carts (11);
the crossbelt carts (11) are moving along a conveying direction (R) on a circumferentially closed conveying track (13) at a travel speed (v);
each of the crossbelt carts (11) comprising a crossbelt (12);
wherein the crossbelt (12) provides a conveying surface for supporting an object (9) to be conveyed;
the crossbelt (12) is selective moving relative to the crossbelt cart (11) in a traverse direction (Q) traverse to the conveying direction (R);
the crossbelt sorter (1) transfers said object (9) from the conveying cart (11) selectively into one of the plurality of discharge stations (14) by selectively driving said crossbelt (12) in the traverse direction (Q);
wherein driving of said crossbelt (12) is initiated when the crossbelt cart (11) is passing a trigger position (Y0, Ya, Yb, Yc) along the track (13), the method comprising the following steps:
changing the travel speed (v) of the crossbelt cart (11), adapting said trigger position (Y0, Ya, Yb, Yc) in dependency of the changed travel speed (v).

13. Method according to claim 12,
characterized by the steps of
determining a quantity of objects to be handled by the crossbelt sorter (1) within a predefined period;
wherein the step of changing the travel speed (v) is based on the determined quantity.

14. Method according to claim 12,
characterized in
that said trigger position (Y0, Ya, Yb, Yc)
is shifted to a more forward position along the track in case the travel speed (v) is reduced,
is shifted to a more rearward position along the track in case the travel speed (v) is increased.

15. Method according to any of claims 12 to 14,
wherein for driving said crossbelt (12) said crossbelt cart (11) has a drive wheel (42) which is at least temporarily engaging with a stationary friction bar (41).

16. Method according to claim 12,
wherein a clutch (43) is provided on the crossbelt cart (12), wherein the clutch (43) selectively closes and/or opens a drive connection (4) between the friction bar (41) and the crossbelt (12) and the drive wheel (42),
in particular wherein the power for opening and/or closing is provided via the drive wheel (42).

17. Method according to claim 12 for operating a crossbelt sorter (1) according to claim 1.
